(19) United States
(12) Patent Application Publication
(10) Pub. No.: US 2008/0178232 A1
(43) Pub. Date: Jul. 24, 2008

(54) METHOD AND APPARATUS FOR PROVIDING USER CONTROL OF VIDEO VIEWS

(75) Inventor: Umashankar Velusamy, Tampa, FL (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Data Services Inc., Temple Terrace, FL (US)

(21) Appl. No.: 11/624,425

(22) Filed: Jan. 18, 2007

(51) Int. Cl. H04N 7/173

(52) U.S. Cl. 725/88; 725/87; 725/131

(57) ABSTRACT

An approach is provided for video view selection. Multiple video feeds, corresponding to different views of a common event, are received. A control signal specifying the desired view of the event is received. Full or a portion of the video feed(s) corresponding to the user's desired view of the event is forwarded to the display.

### BACKGROUND INFORMATION

With the convergence of telecommunications and media services, there is increased competition among service providers to offer more services and features to consumers, and concomitantly develop new revenue sources. For instance, traditional telecommunication companies are entering the arena of media services that have been within the exclusive domain of cable (or satellite) television service providers. Television remains the prevalent global medium for entertainment and information. As such, much attention has been dedicated by the television industry in improving broadcast and display technologies for higher resolution images and greater audio fidelity. Also, the broadcast industry has spent considerable time and effort to developing more and more content. On-demand and digital video recording (DVR) services have permitted users control of their viewing schedules and have provided users with simple playback functions. Thus, television viewers are no longer constrained by actual broadcast times to view programs, as they can start, pause and play a program at their convenience. However, little focus has been paid to enhancing user control of their experience during actual viewing of content.

Therefore, there is a need for providing features that enhance user control of video viewing.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a video system capable of providing user selection of video views, according with an exemplary embodiment;

FIGS. 2A-2D are diagrams of various exemplary configurations of a set-top box capable of communicating with a video control device for user view selection;

FIG. 3 is a flowchart of a process for providing selection of video views, according to an exemplary embodiment;

FIGS. 4A and 4B are, respectively, a diagram of a camera system capable of generating video feeds for the video system of FIG. 1, and a diagram showing an exemplary view path controlled by a user, according to various exemplary embodiments;

FIG. 5 is a diagram of a video transmission system delivering individual video feeds to a set-top box, according to an exemplary embodiment;

FIG. 6 is a flowchart of a video delivery process used in the system of FIG. 5, according to an exemplary embodiment;

FIG. 7 is a diagram of a video transmission system delivering a composite video feed to a set-top box, according to an exemplary embodiment;

FIG. 8 is a flowchart of a video delivery process used in the system of FIG. 7, according to an exemplary embodiment;

FIG. 9 is a diagram of a video transmission system in which video view processing is performed external to a set-top box, according to an exemplary embodiment; and

FIG. 10 is a diagram of a computer system that can be used to implement various exemplary embodiments.

### DETAILED DESCRIPTION OF PREFERRED EMBODIMENTS

An apparatus, method, and software for providing video view selection are described.

In the following description, for the purposes of explanation, numerous specific details are set forth in order to provide a thorough understanding of the various exemplary embodiments. It is apparent, however, that the various exemplary embodiments may be practiced without these specific details or with an equivalent arrangement. In other instances, well-known structures and devices are shown in block diagram form in order to avoid unnecessarily obscuring the exemplary embodiments.

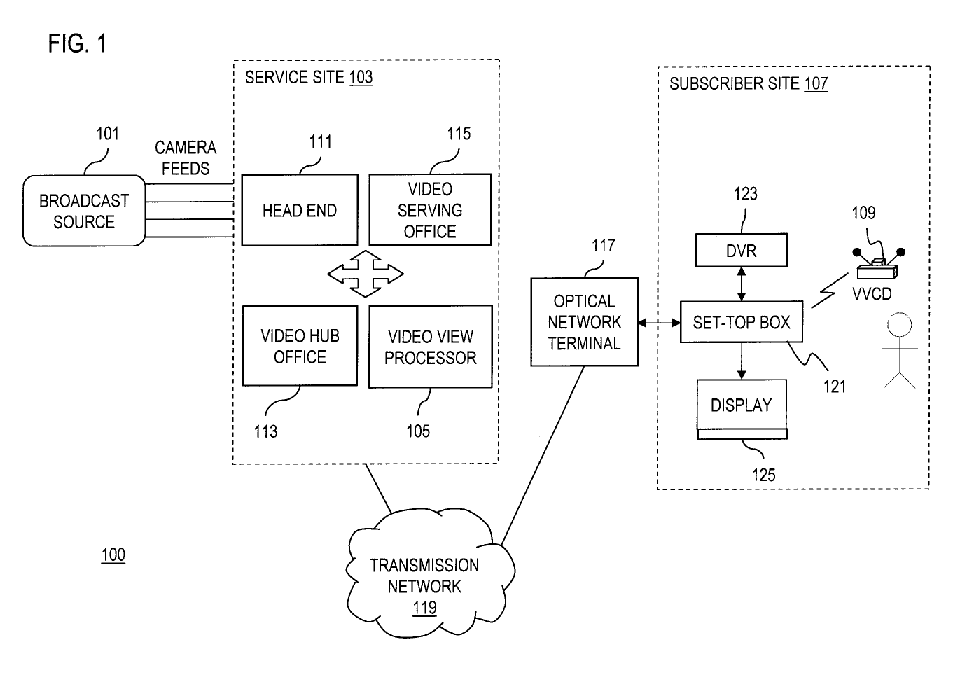

FIG. 1 is a diagram of a video system capable of providing user selection of video views, according to an exemplary embodiment. For the purposes of explanation, this exemplary scenario is described in the context of a live broadcast feed; however, other video sources can be used as the feed (e.g., pre-recorded programs). A video system 100 provides for a broadcast source 101 that generates multiple broadcast feeds corresponding to multiple cameras that are utilized to cover an event. The multiple cameras can be deployed to provide different views of the event. In accordance with an exemplary embodiment, service site 103 employs a video view processor (VVP) 105. The VVP 105 uses feeds from one or more cameras to provide a view of the event in an manner desired by the user (or subscriber) at the subscriber site 107 through a video view control device (VVCD) 109, thereby creating a “total view” of the event. That is, the user need not preview various views of the event or select the view from a choice of multiple views shown in small windows. Instead, the user can operate the VVCD 109 to specify the directional movements, such as by using joystick device (e.g., combination of Left, Right, Up, Down). The VVCD 109 can automatically change the views by choosing feeds from appropriate cameras in response to the user's actions. In an exemplary embodiment, the users, in addition to selecting the views from the cameras of their choice, can be placed virtually within a scene through a view selection (e.g., first person view), which automatically triggers selection of an appropriate camera, along with the optical or digital zoom level, position in a 3-dimensional space, angle, rotation of the camera, etc. The user is provided with various capabilities to manipulate the views by controlling the following exemplary parameters: angle for viewing the event, position from which the event is viewed in three-dimensional space, the rotation of the view, the size of the field of view, the proximity to the focal point (zoom level), etc.

Specifically, by providing the user with the capability to control the views to be shown on a display screen using the VVCD 109, the user can not only experience a feeling of being within the scene, but will also appear to have the ability to control a “virtual camera,” which can be placed and moved anywhere in the coverage area in three-dimensional space, thereby providing the user with a first person view of the event As the user “moves” through the scene, the VVP 105 ensures that the full screen action for the user, either by seamlessly providing parts of the area covered by a single camera, or by interpolating (or “stitching”) frames to provide a smooth transition between cameras or by generating frames based on inputs from one or more cameras, in response to the user's actions to the view the event in a desired way. In an exemplary embodiment, the video view processor 105 can apply video effects to the feeds, such as digital zooming, run-time morphing, etc.; these effects can then be provided to the user for selection by the VVCD 109.

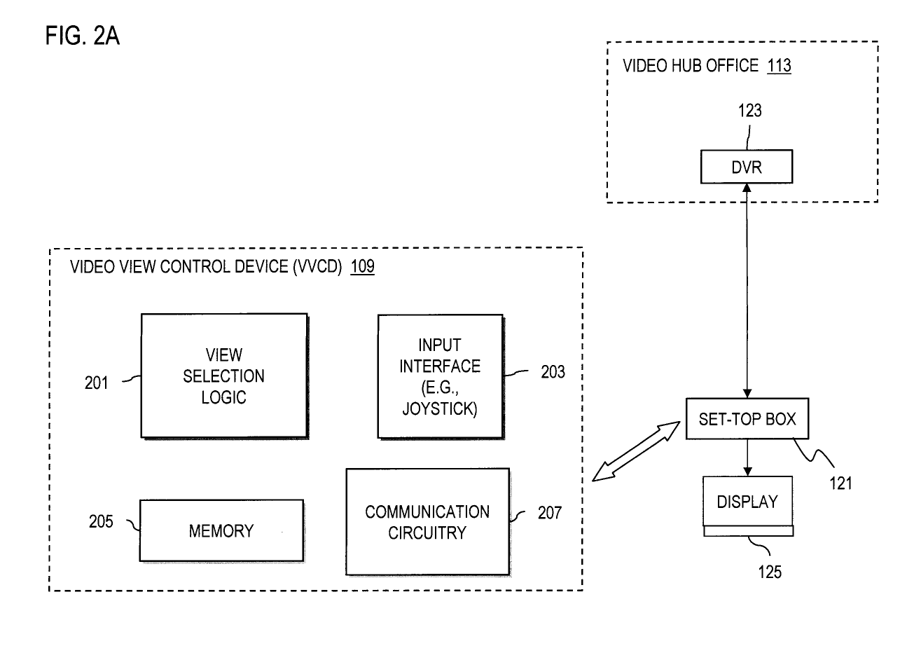

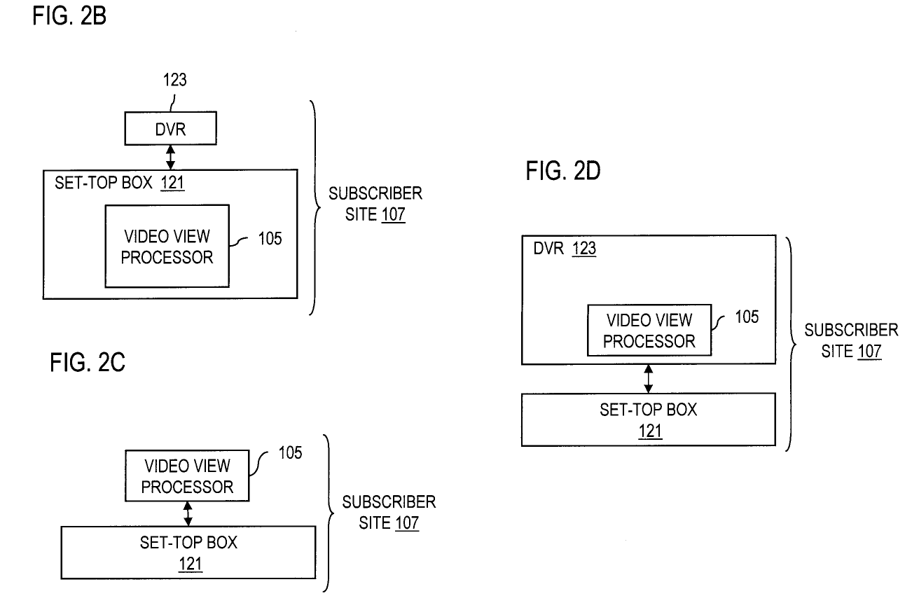

Although shown as part of the service site 103, it is contemplated that the video view processor 105 can be deployed elsewhere—e.g., within the subscriber site 107 (as illustrated in FIGS. 2B-2D). The view selection mechanism of the system 100 can also be applied to non-real time processing of the video feeds to create the “total view” effect. For example, the video feeds can be buffered or otherwise stored (e.g., through a digital video recorder (DVR) within the network or on the subscriber (or customer) premises) and subsequently processed by the video view processor 105.

Traditionally, TV viewers are provided with views that are not user controllable. In other words, these viewers do not have an option to view a particular event (e.g., a football game) from a view or perspective of their choosing. Despite the existence of multiple feeds, all the varying camera feeds are not traditionally broadcast to head-ends (or to the subscriber premises), as to preserve transmission resources. This also leaves the creative control to designated personnel of the broadcasting company (e.g., producer, director, camera operator, etc.) to select the particular camera feed to be broadcast as the viewable video transmission. Thus, in conventional systems, end-user viewers are generally restricted to viewing a feed from a single camera at any given time for a particular channel. Such feed contains only predetermined views as determined by the broadcasting company.

As shown, the example service site 103 includes a head end 111 to receive the video feeds from the broadcast source 101. The service site 103 also provides functions of a video hub office 113 and a video serving office 115. The video hub office 113 can insert additional content, whereby local channels, commercials and video-on-demand programs are added to a national program, for example. The video serving office 115 processes the video signals, and relays the signals to the subscriber site 107 via a network terminal 117 over a transmission network 119. According to one embodiment, the transmission network 119 is an optical system; and thus, the network terminal 117 is an optical network terminal that connects to the set-top box 121. Other system configurations for video distribution can also be employed, as is well known.

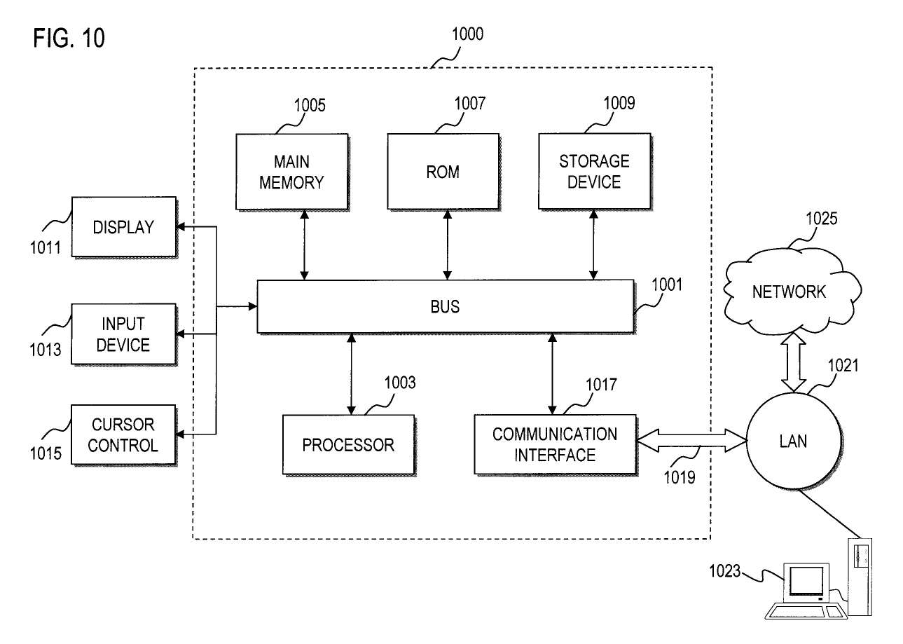

At the exemplary subscriber site 107 may be the set top box 121. Set top box 121 may comprise a computing platform (such as described with respect to FIG. 10) and include additional facilities configured to provide specialized services related to the reception and display of video (e.g., remote control capabilities, conditional access facilities, tuning facilities, multiple network interfaces, audio/video signal ports, etc.) The set-top box 121 may interact with a digital video recorder (DVR) 123 to store received video signals, which can then be manipulated by the user at a later point in time. A display 125 presents the video content from the set-top box 121 to the user.

FIGS. 2A-2D are diagrams of various exemplary configurations of a set-top box capable of communicating with a video control device for user view selection. As shown in FIG. 2A, the video view control device 109 provides the viewer with an ability to watch an event, e.g., a sports game, from any available view at a particular time. The user can also change the view dynamically, while maintaining full screen action, without having to preview the list of available views and selecting from one of the views. As seen, the video view control device 109 includes a view selection logic 201 that interacts with an input interface 203 for determining the particular video feed(s) that the user desires to view. In an exemplary embodiment, the input interface 203 includes a joystick (or other controller device), which the user can readily control to dynamically change parameters that affect the view of the event, such as viewing angle, position from which the event is viewed in three-dimensional space, zoom level, rotation of the camera, special effects, etc. The input interface 203 can be integrated with a remote control device (not shown) for controlling the set-top box 121. The video view control device 109 can also include a memory 205 for storing the choices affecting the view, which are then conveyed to the set-top box 121 through communication circuitry 207. The communication circuitry 207 can support any type of wired and/or wireless link—e.g., infrared, radio frequency (RF), etc. The memory 205 also stores user preferences with respect to the views, such as favorite views, etc. Alternatively, the user preferences that are input through the VVCD 109, can be tracked, recorded, or stored in the set top box 121 or in a network drive (as in the system of FIG. 2A). The preferences can be automatically retrieved and activated by the user at any time. It is noted that video view control device 109 may be separate from the set top box 121 or may be integrated within the set top box 121 (in which case certain communications circuitry 207 may not be necessary).

The exemplary configuration of FIG. 2A provides a DVR capability external to the subscriber site, for example, within the video hub office 113 for storing the video feeds. It may be a network DVR that records the feeds from different cameras, for use by more than one user attempting to obtain the customized view(s) from the recorded content of the coverage, for instance, a slow motion play back from different angles or zoom levels or both. Alternatively, the DVR 123 can reside within the subscriber site, as shown in FIG. 2B.

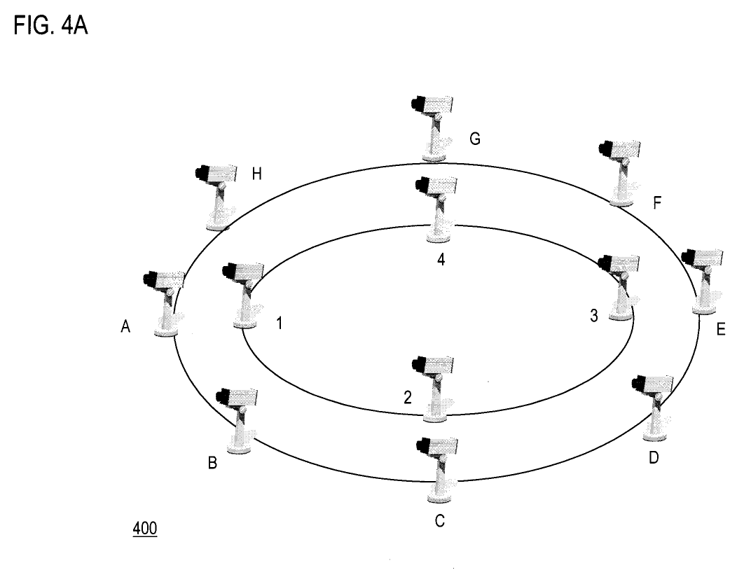

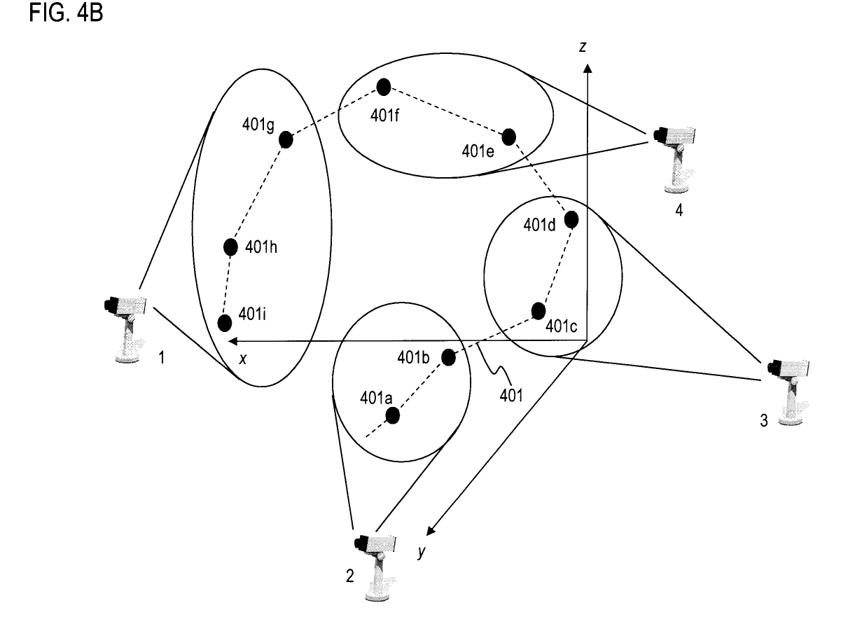

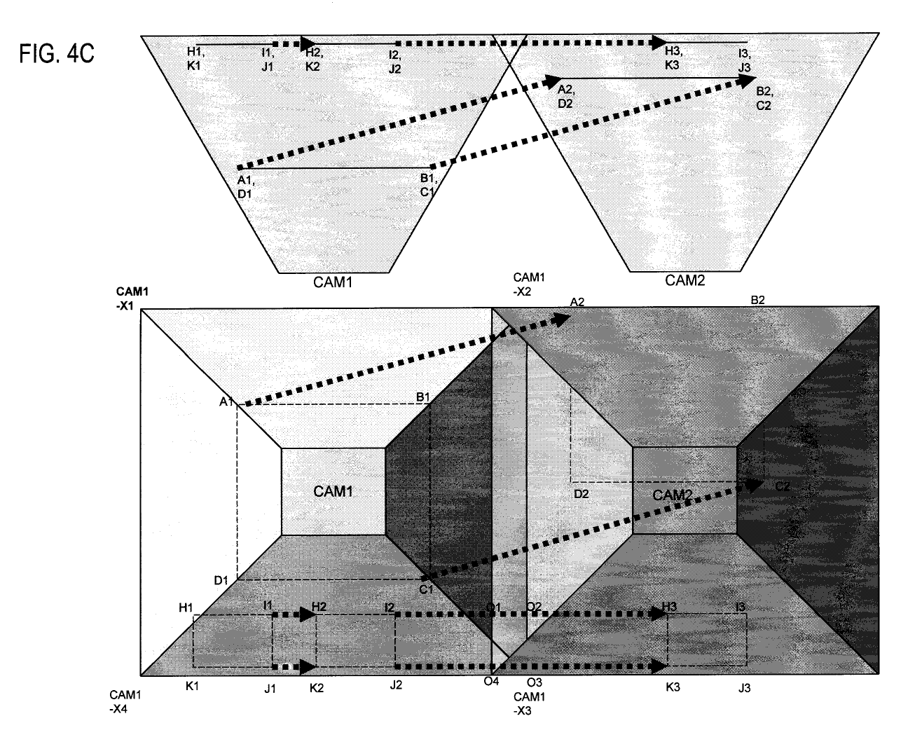

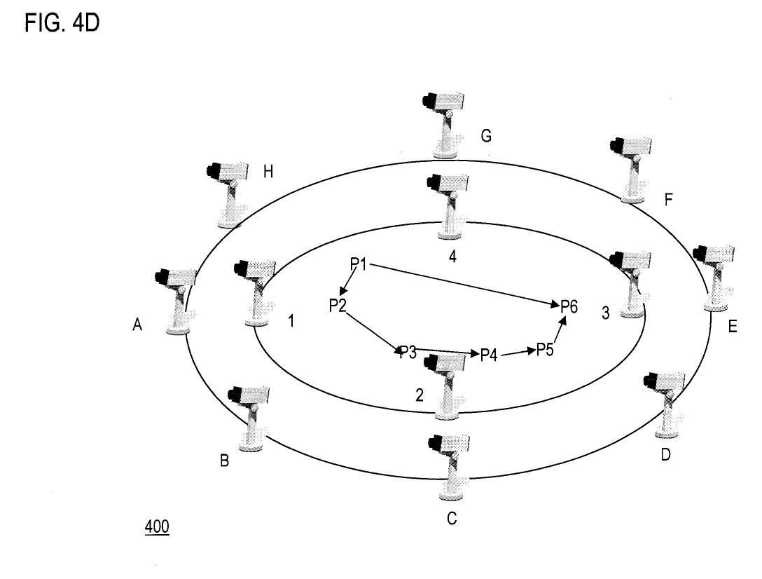

With the view control device 109, viewers can effectively determine their own viewing experience, without being restricted by the broadcasting company. The users can perform such operations selection of the camera to immediately see the view from the camera of their choice, by operating the VVCD. Depending on the camera set-up, the user can simulate a first person view of the game with the capacity to “fly” around the coverage area, for example, the stadium/sports arena (as described below with respect to FIG. 4B). In an exemplary embodiment, the view control device 109 can be configured to provide buttons or the like, allocated to specific views (for example, in a user interface and/or in connection with the joystick control), wherein the buttons can be assigned to provide shortcuts to certain views, such as East Upper, South East Ground Level, etc, which may include the choice other variables such as digital/optical zoom level, etc. When selected, the presented view can be smoothly transitioned from the existing view to the chosen view, simulating a flight effect. As mentioned, the transition may require the VVP 105 to generate frames (or scenes) using a mixing or interpolation algorithm; this mixing/interpolation may be required to assist with this simulation. Views of the viewer's choice can be preset, and the trajectories of the virtual camera can also be recorded as shown in FIG. 4B for instance, and assigned to the shortcut buttons. The assignment information of the shortcut buttons can be stored in the memory 205 (FIG. 2A) of the view control device 109.

Thus, the view control device 109 allows for choosing a desired view with a relatively smooth transition from the current view and the next view, permitting the user to rapidly and comfortably acquire the desired view. It is noted that the view control device 109 can also support a menu selection approach to view selection; for example, certain views can be presented as small windows, such as in a Picture-in-Picture mode, allowing for user selection. This is not a preferred approach, as it requires the viewer to have knowledge of the viewing angles/positions, a sudden switch in feeds may be disorienting to the viewer, and the viewer would miss the scenes in full screen until the desired feed is chosen. Further, if the number of views is large, displaying all the views would be infeasible as the images would be too small, and the selection process would be even slower. Under such an approach, by the time a user attempts to select a view (or channel), the scene of interest may have passed.

As noted, other configurations for implementing the VVP 105 and the DVR 123 are contemplated, as shown in FIGS. 2B-2D. The configuration of FIG. 2B provides the VVP 105 within the set-top 121 itself. As a result, the subscriber site 103 need not provide such functionality. In another exemplary embodiment (FIG. 2C), the VVP 105 can be provided as a separate customer premises equipment (CPE); this configuration permits subscribers to use their existing set-top boxes 121. Moreover, as illustrated in FIG. 2D, the VVP 105 can be deployed within the DVR 123.

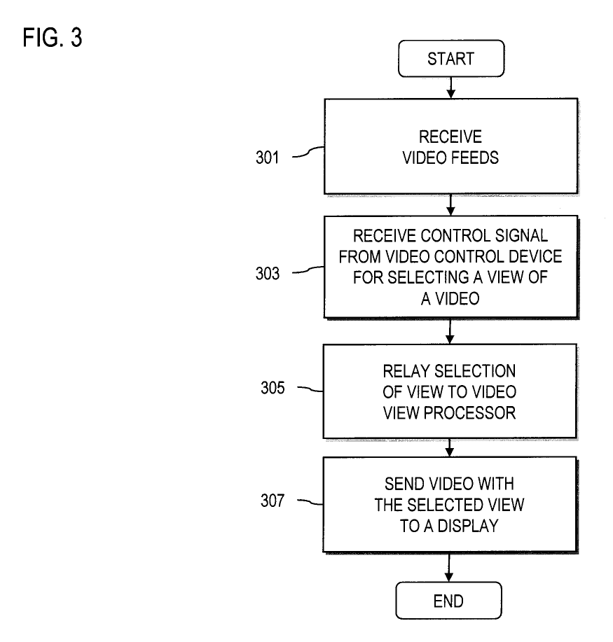

FIG. 3 is a flowchart of a process for providing selection of video views, according to an exemplary embodiment. In this example, the video view processor 105 resides within the service site 103, as illustrated in FIG. 1, and a network DVR 123 is provided. In step 301, the set-top box 121 receives the video feeds from the DVR 123, for example. The user, at this point, can use the video control device 109 to select a view, as in step 303. The set-top box 121, per step 305, communicates the request by the video control device 109 to the VVP 105 within the service site 103 for mapping of that selection to one of the camera feeds; the appropriate feed is then delivered to the set-top box 121 via the DVR 123. In other words, the view selection is communicated to the VVP 105, which creates a custom feed using the appropriate cameras, and only the custom video feeds are provided to the set-top box 121. In step 307, the set-top box 121 sends the customer video feed to the display 125 (per steps 305 and 307).

FIGS. 4A and 4B are, respectively, a diagram of a camera system capable of generating video feeds for the video system of FIG. 1, and a diagram showing an exemplary view path controlled by a user, according to various exemplary embodiments. Under this scenario, a camera system 400 is provided for an event that is taking place within an arena (or stadium), as shown in FIG. 4A. TV broadcast of this event involves coverage with a number of cameras placed in and around the stadium in strategic locations. In this example, cameras 1-4 are situated at a lower height than cameras A-H. In each of the scenarios below, the cameras can be static or moving. The viewing information about the cameras in the field (e.g., their angle of view, zoom levels etc.) are communicated to the VVP 105 along with the feed. The VVP 105 can then use this information to compute views to be displayed in the user's screen based on the user's actions using the VVCD 109.

By way of example, the event could be a football game, such that the one set of four cameras (e.g., #1 at West End, #2 North, #3 South, #4 at East End) is at the lower level to cover the ground level of the game. The other set of 8 cameras at the upper level (e.g., A, B, C, D, E, F, G, and H), covering the game from atop the stadium. In a conventional TV broadcast, the viewer is shown only one view of the stadium at any one time. If the ball is in the middle of the stadium, the feed from any camera can be chosen for broadcast. For instance, if there is a touchdown in the east end, a more appropriate feed from the cameras 3, F, E, D or even 2, 4, G and C can be chosen for broadcast. With exemplary video system 100, however, the user within the subscriber site 107 can manipulate the view control device 109 to select a particular camera or a particular viewing angle based on height and location within the stadium.

Further, for the particular camera or viewing angle, a desired zoom level can be specified in real-time or near real-time; this video processing can be a digital zoom function performed by video view processor 105. In an exemplary embodiment, the video view processor 105 (of FIG. 1) can create “first person” views through dynamic camera selection and manipulation of the cameras, adjusting the angle, zoom levels, etc. as needed. Accordingly, the viewer in effect is able to control, for example, the direction of view, height from which the game is being viewed, or the zoom level of the given view. The choices of views are only limited by the number and positions of the cameras placed in the stadium, and the resolution of the camera. Not only will the viewer have the choice of the view, but the viewer can simulate a first person view of the event.

This unique user experience is enabled by continually changing the choice of the feed from different cameras in the stadium, and simultaneously digitally zooming the live feed, in response to user's actions on the VVCD 109. In other words, to the user, it will appear as if the viewer is controlling a “virtual” camera (formed by the collective cameras) that moves to various locations in the stadium with the user being able to control both the position of the camera and also what the camera “sees.” The follow scenario is illustrative. Initially, the user sets the VVCD 109 to view the game from camera A (located in the west upper end of the stadium). As the user moves the joystick (or other directional controller) of the VVCD 109 to the right, the display 125 shows views that progressively shift, from cameras A->B->C->D->E->F->G->H->A (at the same height and zoom levels). Similarly, the user can trace the ball as it proceeds from a ground level view by lowering the controls in the VVCD 109 to go down, effectively choosing the lower level cameras (e.g., 1->2->3->4) and controlling the direction of movement of the virtual camera. In an exemplary embodiment, the progression from one camera to another camera is seamless, as the VVP 105 can create the necessary frames, either in whole or in part, from one or more cameras, to “fill-in” any necessary scenes to maintain the full screen action for the user. The choice of the cameras, and the view from them can be automatically determined based on the user's action through the VVCD 109. Information about the “location” of virtual camera, such as position in a three-dimensional (3D) space, angle of view, zoom level, area of the field of view being viewed, etc. can be computed in real time, and the views presented to the user adjusted accordingly. This computation can be performed in the VVCD 109, or in the VVP 105 (e.g., as in the configuration of FIG. 2B), depending on the signals from the VVCD 109. The view displayed within the display screen 125 at any given time, may originate from one or more cameras, either in full or in part, and may be entirely real or partially mixed/interpolated.

It is also possible to simulate different “flight” paths of the virtual camera, from the top of the west end of the stadium (camera A), to south end of the lower level (camera 2), ending with a view of the stadium from east at the ground level (camera 3). As described, such flight paths can be stored and later invoked. This capability is illustrated in FIG. 4B.

By way of example, a first person view can follow a path 401, starting at point 401a to end point 401i. The user can “walk” from point 401a to point 401b. These points 401a, 401b, in this example, can be covered by camera 2, which can zoom in appropriately to simulate the effect of being in the scene. As the user controls the VVCD 109 to points 401c and 401d, the VVP 105 can switch to camera 3. At point 401d, the user elevates to a different height and continues up to points 401e and 401f (as provided by camera 4). Thereafter, the user begins to descend along points 401g, 401h and 401i; these views are provided by camera 1. Under this “total view” capability, the user does not select a camera, per se, but a view, and associated path (e.g., path 401). The VVP 105 executes an algorithm to control camera selection and camera parameters; the algorithm can invoke an interpolation or stitching function to create transition scenes, as necessary. As described, the VVCD 109 can provide hot buttons to record the path 401, such that user can invoke the views during a later point of the event.

Additionally, the VVCD 109 can record a particular target point along the path 401 (or any other point within the arena); in this manner, the user can rapidly return to the scene.

Further, this return (or jump) from another point can be performed smoothly along a default path generated by the VVP 105, or the view can be transitioned abruptly. That is, the user can select the desired camera to change to, and select how the transition will occur—e.g., either abruptly or with a fly-by-effect, etc.

The user can either view the complete area covered by any camera in full screen or only a part of the coverage area in full screen. That is, the virtual camera of the user can either be an actual camera by itself, or a part thereof. If the user is viewing only a part of the coverage area and using the VVCD 109 to control the movement of the virtual camera of the user, and hence the views that the user sees, the video data can originate entirely from a single camera (although the user may not be aware of this fact).

For example, in FIG. 4C, a user may be viewing the entire coverage area CAM1-X1, X2, X3, X4 in full screen, and then view only the area H1-I1-J1-K1 in FULL SCREEN. If the user now chooses to move horizontally, the user uses the VVCD 109 to move the virtual camera first person view (now H1-I1-J1-K1) to the right a little bit—not changing any other parameters.

The new view would be “H2-I2-J2-K2”; but it may be noted that the source is still the same camera (CAM1). As the user moves further right (which can occur at an instant), if the virtual camera goes beyond the coverage area of CAM1, then the feed from CAM 2 is picked up automatically and transitioned smoothly to the new position H3-I3-J3-K3.

The VVP 105 may utilize the feed from both CAM1 and CAM2, in the overlapping coverage area O1-O2-O3-O4 to mix an appropriate view for the user, such that the user is viewing the event through a virtual camera without any breaks. In the event of an absence of an overlapping coverage area between CAM1 and CAM2, the VVP 105 might select views from other cameras in the field, such as CAM3, which could be located far behind CAM1 and CAM2, but provides coverage of the missing area (in which case, the feed from CAM3 would be zoomed in to maintain the view of the virtual camera, when transitions from CAM1 to CAM2 occur). In the absence of coverage from any of the cameras, video data can be interpolated, or the transition can be abrupt.

Similarly, considering A1-B1-C1-D1 as the view as seen by the user in the display screen, the user may choose to move up and across, but want to get closer to the subject at the same time, resulting in view A2-B2-C2-D2. In this case, the view from CAM2 would have been zoomed in toward the subject, i.e., the virtual camera would be closer to the subject as illustrated in the top view of FIG. 4C.

Furthermore, the user, in an exemplary embodiment, can specify the subject that should be the focus of the views, and simply control the choice of the cameras. For example, if the event is a football game, the user may designate the football as the focus at all times, and would select the different views as the football moves across the stadium. With this capability, is the user is free from having to focus on a subject as well as having to control the movement and other parameters of the virtual camera. Accordingly, the VVP 105 primarily uses those feeds that contain the user's subject of choice in the field of view.

The VVP 105, in addition to receiving the information about the location information of cameras, can also receive, track and record position information in two dimensions (2D) or three dimensions, of various subjects in the field (e.g., football, specific players, etc.). Various known techniques can be used to detect and track the position of the subjects. For example, as shown in FIG. 4D, the user can choose to change the view from camera H at the top level to camera 3 at the lower level (having fixed the subject already, and chosen the option for automatic flight path generation instead of abrupt transition from camera H to camera 3). In this manner, the VVP 105 may use the feeds from either cameras G, F, or 4 or from all of them to simulate a flight path of the virtual camera, with the camera focusing on the movement of the football at all times from position P1 to P6. Alternatively, the user can operate the VVCD 109 in such a way as to reach the view through Camera 3 by moving in a counter-clockwise direction, while the football moves through path P1-P2-P3-P4-P5-P6. The VVP 105 might appropriately use the feeds from cameras A, B, C, 1, 2, D or E or any combination of such cameras to present a smooth fly by effect for the user as the user moves through the field. The flight path and positions can be recorded for later application and/or replay of the event. It is noted that a variety of camera arrangements can be created, depending on the event and the desired user experience the broadcaster is willing to support. For example, in case of a stadium with a swimming pool, cameras can be located both above and below the water level. In this configuration, a 360° movement of the virtual camera below and above the swimming pool can be provided.

Moreover, the user may also be shown the actual positions of the cameras by means of a 3D model of the coverage area; e.g., a three-dimensional model of a stadium with the camera positions indicated. Also, in any given view, the user may press a button or the like, whereby the position of the cameras can be revealed to the user in the same display screen. The position of the virtual camera can also be shown in a separate window, thus providing the user an option to see where the user is in three-dimensional space. The camera position views can also be shown in a small window at any given time, so the user can easily choose the camera.

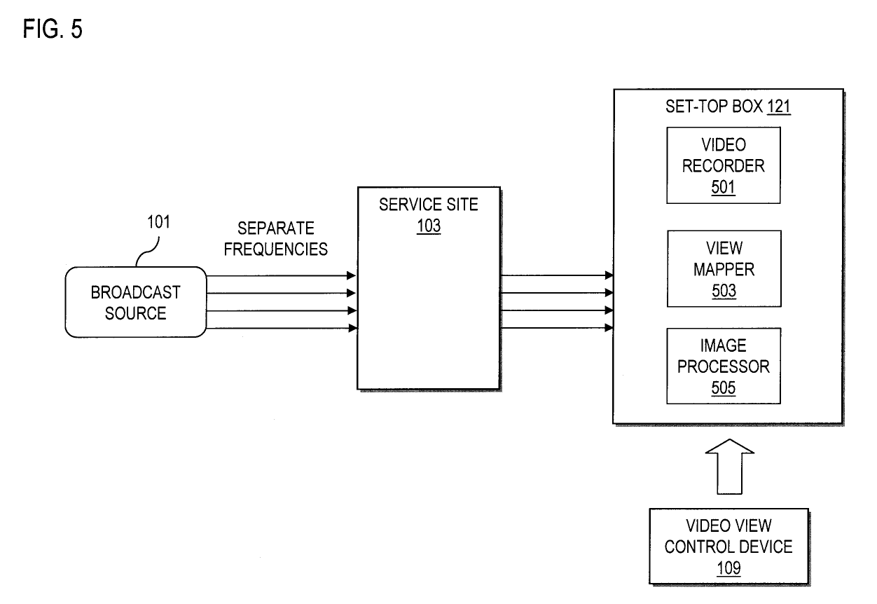

The described view selection process can be implemented in a variety of ways. By way of example, three approaches are explained, per FIGS. 5-9.

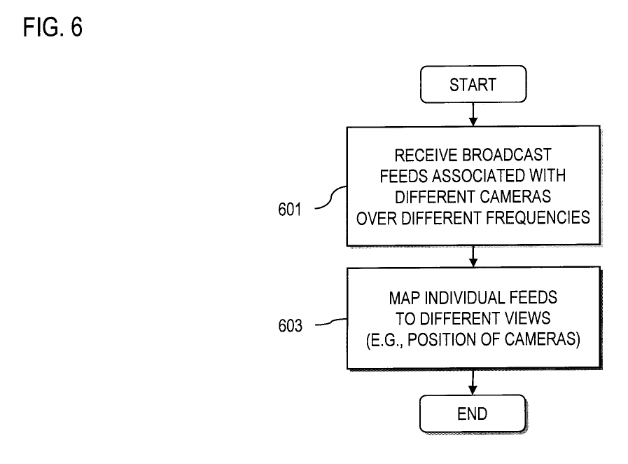

FIG. 5 is a diagram of a video transmission system delivering individual video feeds to a set-top box, according to an exemplary embodiment. The operation of this system is explained with respect to the flowchart of FIG. 6. In this exemplary embodiment, the service site 103 receives feeds from different cameras over predetermined frequencies, channels or other delineations, respectively (per step 601). These feeds are forwarded to the set-top box 121, per the capabilities of transmission network 119. Unlike the configuration of the set-top of FIG. 1, this set-top box 121 includes a digital video recorder (DVR) 501 that is internal to the set-top box 121. In an exemplary embodiment, the DVR 501 stores the feeds from all the cameras for a specified amount of time, so the event can be recreated and the associated views can be manipulated.

Additionally, a view mapper 503 within the set-top box 121 maps the individual feeds to different views (e.g., corresponding to the cameras), as in step 603, for selection by the user. The view mapper 503 can execute a protocol for enabling the set-top box 121 to perform the mapping function.

Based on the control signals from the VVCD 109, the set-top box 121 can elect the feed to be displayed in the current viewing channel. The VVCD 109 can also specify a desired zoom level of the cameras; this invokes an image processor 505 to digitally zoom into the selected view or perform other operations (e.g., apply effects affecting the view).

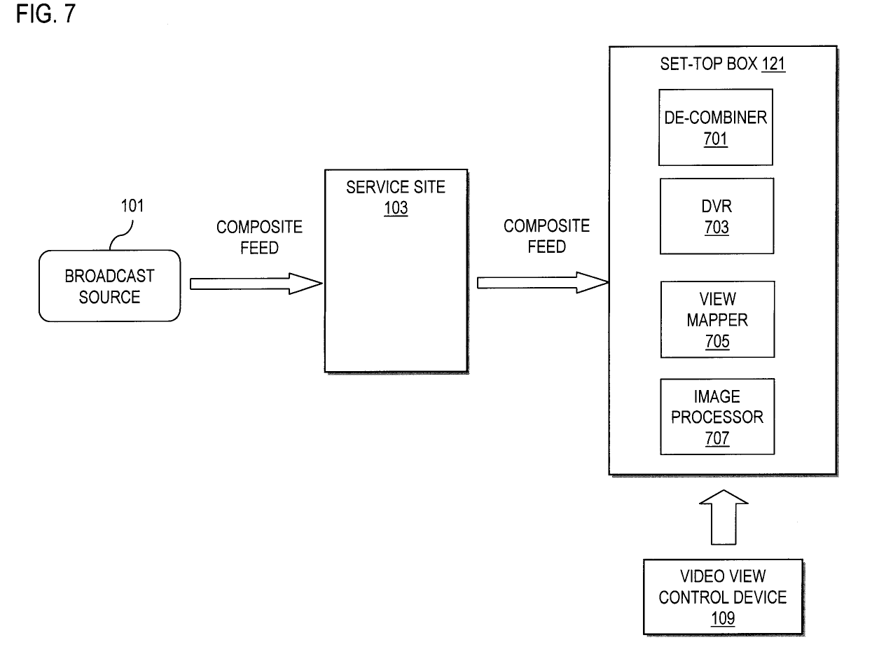

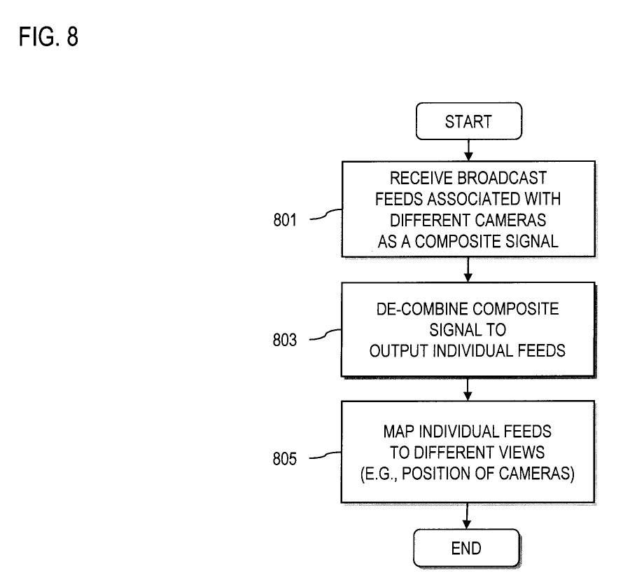

FIG. 7 is a diagram of a video transmission system delivering a composite video feed to a set-top box, according to an exemplary embodiment. Under this scenario, the video feeds are transmitted from the broadcast source 101 as a composite signal or feed. Namely, the feeds from the different cameras covering the event are broadcast as composite images. That is, the individual frames from each camera shot at the same time are combined together and sent as a single frame, along with the information to separate (or de-combine) the individual frames and identify the respective cameras with view information, including the position in a three-dimensional space, the coverage area, the direction etc . . . As shown in FIG. 8, the set-top box 121 receives the feeds as a composite signal, as in step 801. The set-top box 121 utilizes a de-combiner 701 (i.e., logic to de-combine the composite signal) to de-combine or extract, as in step 803, the frames from the composite set, and selects only those frames based on the operations of the VVCD 109, in which the appropriate zoom levels are applied. As with the set-top box 121 of FIG. 5, a DVR 703, a view mapper 705 and an image processor 707 are included. The view mapper 705, per step 805, maps the extracted individual feeds to the different views.

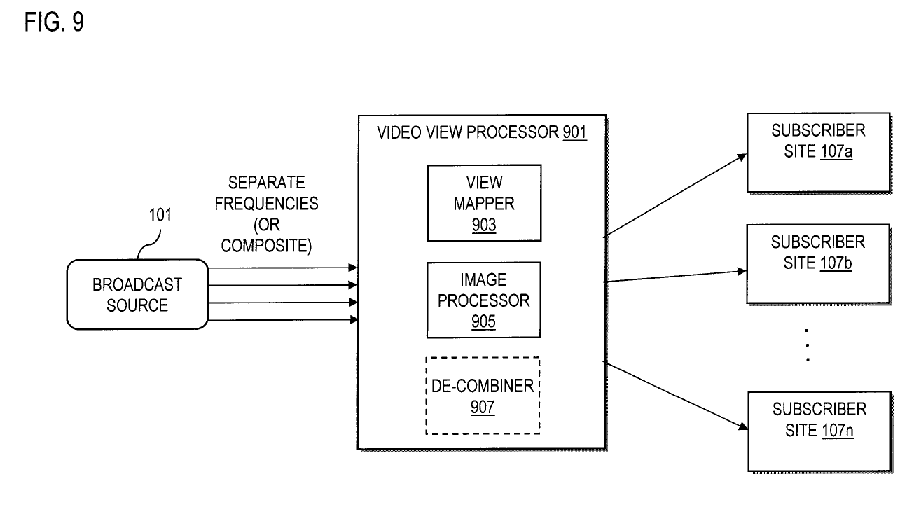

FIG. 9 is a diagram of a video transmission system in which video view processing is performed external to a set-top box, according to an exemplary embodiment. In this example, a video view processor 901 assumes the functions of the set-top box configurations of FIGS. 5 and 7. The video view processor 901 can reside within the service site 103 (as in the case of FIG. 1). Alternatively, the processor 901 can be implemented in a video serving office (VSO) or a video hub office (VHO). As shown, the processor 901 can service multiple subscriber sites 107a-107n.

Under this arrangement, the set-top boxes effectively act as relay devices for relaying the commands of the VVCD 109 to the video view processor 901. Specifically, the processor 901 performs the necessary operation of choosing the desired picture, applying the zoom levels or other effects, and feeding the video feed via the set-top box to the display for viewing by the user. The processor 901 includes a view mapper 903, and an image processor 905. Optionally, a de-combiner 907 is utilized if the broadcast source 101 outputs a composite feed.

This exemplary embodiment reduces the processing load from the set-top boxes. As shown, the video view processor 901 serves multiple customers. In an alternative embodiment, the processor 901 can be deployed within the subscriber site 107 if multiple set-top boxes are utilized within this site.

The above described processes relating to video view selection may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 10 illustrates a computer system 1000 upon which an exemplary embodiment can be implemented. For example, the processes described herein can be implemented using the computer system 1000. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to one embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the exemplary embodiment. Thus, exemplary embodiments are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an exemplary embodiment through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the various exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
receiving a plurality of video feeds corresponding to different views of a common event;
receiving a control signal specifying selection of one of the views by a user; and
forwarding the video feed corresponding to the one selected view to a display.

2. A method according to claim 1, further comprising:
receiving another control signal; and
dynamically changing the video feed to another one of the video feeds in response to the other control signal.

3. A method according to claim 1, wherein the control signal is output from a control device that includes a joystick controller for selecting the video feed.

4. A method according to claim 1, wherein the video feed is forwarded to a set-top box configured to output to the display.

5. A method according to claim 4, wherein the video feed is forwarded to the set-top box over an optical transmission network.

6. A method according to claim 1, wherein the video feeds are received over a plurality of carriers having different frequencies.

7. A method according to claim 1, wherein the video feeds are received over a composite signal.

8. A method according to claim 1, wherein the display maintains a full screen of the video feed during view selection by the user.

9. A method according to claim 1, wherein the control signal further specifies a zoom level, the method further comprising:
digitally zooming in on the video feed according to the specified zoom level.

10. A computer-readable storage medium configured to store instructions to execute the method of claim 1.

11. An apparatus comprising:
a video view processor configured to receive a control signal specifying selection by a user of a view among a plurality of views, wherein the views are associated with a common event and correspond to a plurality of video feeds, and the video feed corresponding to the one selected view is forwarded to a display.

12. An apparatus according to claim 11, wherein the video view processor is further configured to receive another control signal, and to dynamically change the video feed to another one of the video feeds in response to the other control signal.

13. An apparatus according to claim 11, wherein the control signal is output from a control device that includes a joystick controller for selecting the video feed.

14. An apparatus according to claim 11, wherein the video feed is forwarded to a set-top box configured to output to the display.

15. An apparatus according to claim 14, wherein the video feed is forwarded to the set-top box over an optical transmission network.

16. An apparatus according to claim 11, wherein the video feeds are received over a plurality of carriers having different frequencies.

17. An apparatus according to claim 11, wherein the video feeds are received over a composite signal.

18. An apparatus according to claim 11, wherein the display maintains a full screen of the video feed during view selection by the user.

19. An apparatus according to claim 11, wherein the apparatus is a set-top box.

20. An apparatus according to claim 11, wherein the control signal further specifies a zoom level, the video view processor being further configured to digitally zoom in on the video feed according to the specified zoom level.

21. A method comprising:
receiving an input signal from a user specifying a view among a plurality views of an event;
generating a control signal in response to the input signal; and
forwarding the control signal to a set-top box, wherein the set-top box is configured to output a video feed corresponding to the specified view to a display.

22. A method according to claim 21, wherein the input signal further specifies a zoom level of the view.

23. A computer-readable storage medium configured to store instructions to execute the method of claim 21.

24. An apparatus comprising:
an input interface configured to be controlled by a user and to output an input signal specifying a view among a plurality views of an event;
view selection logic configured to generate a control signal in response to the input signal; and
radio circuitry configured to forward the control signal is to a set-top box, wherein the set-top box is configured to output a video feed corresponding to the specified view to a display.

25. An apparatus according to claim 24, wherein the input signal further specifies a zoom level of the view.
